(19) United States
(12) Patent Application Publication
(10) Pub. No.: US 2024/0289897 A1
(43) Pub. Date: Aug. 29, 2024

(54) Leaders Lost Process

(71) Applicant: clarence zachary graves, virginia beach, VA (US)

(72) Inventor: clarence zachary graves, virginia beach, VA (US)

(21) Appl. No.: 18/212,543

(22) Filed: Jun. 21, 2023

Related U.S. Application Data
(60) Provisional application No. 63/576,657, filed on Feb. 27, 2023.

(51) Int. Cl. G06Q 50/00

(52) U.S. Cl. CPC G06Q 50/01

(57) ABSTRACT

Leaders Lost will revolutionize the art of digital publishing to create a more free and informed world based more on open and transparent dialogue and common understanding of ideas instead of algorithm based interpretations and perception driven reactions to self-interested or perhaps nefarious influencers. Leaders Lost will provide a methodology for sharing of ideas like the book did with the creation of writing. Leaders Lost will allow the human condition to take back and control the information domain from the computer and ghost protocols disrupting our societies and communities.

### BACKGROUND

Leaders Lost is the calculus of human understanding-that is understanding changes across a system of written ideas to understand the true nature behind those ideas within the context of the changes being looked at, and to tell us something about ourselves, how we govern our society, and interact to resolve conflict. Leaders Lost is a process, an approach for deriving the truth behind a story, creating a better more foundational context through which to learn from.

### SUMMARY

I invite you to interact with, share, contribute to (with content or funding), and assist by providing your own opinion or analysis. The Leaders Lost Process represents and embodies more than your typical social media or book publication. Leaders Lost allows me the author of the story to interact directly with the audience in real time through the Leaders Lost sites leveraging a series of social media and other indicators and potential tools, independent of the algorithms, to develop a better understanding of the Truth behind the supposed facts or ideas in the story. The content of the story is uniquely broken up and organized originally by each page representing an interactive post, tweet, or other source which can be analyzed and digested independently at the leisure of the audience to like, share, re-tweet, love, comment, or even provide opinion or recommend edits about the material or substance behind the idea or snapshot presented within that page of the story. I lived the story and have shared it with you and now I want to know what I got right, grossly misjudged, new information I didn't see coming, or simply whether you liked the content and real-life story it represents. More than anything though, I want the audience to objectively see and learn academically and analytically, not from opinion or algorithm, but instead from my mistakes, successes, and what we learn from the story together in this new, restorative, transparent, open, interactive, and continuous dialogue in the Leaders Lost Process: Where a foundation in truth, accountability, and knowledge create a better, more informed society.

### DESCRIPTION

Live: The Leaders Lost Process is a new and unique process improved from existing elements of and tools for organizing, presenting, sharing, and analyzing information for the purposes of communicating content for useful application of the ideas being conveyed. The most elemental of these tools, the book, gets combined with and presented in a unique manner using the most recent of these tools, social media, and applied using this new technique to more effectively and openly pinpoint and understand the key changes in the story.

Shine: The analysis of these changes (through the new data and idea generation) in the story to establish a better understanding of the truth comes from the combined and continuous interaction with the independent public and transparent sharing of ideas related to the individualized content broken up in the pages. Just as the study of these changes across a particular span of control can provide the mathematician a means for understanding the full range of changes taking place that make up the function to understand something more interesting or complete about performance of the mathematical activity or model, we use the continuous process through Leaders Lost to also understand the limited changes taking place across the story in a controlled span of each page in order to develop and see more clearly into the total and more complete understanding of the truth taking place behind the story or material being presented. Once this process has been used to express the consolidation of user feedback in the presentation of the subject matter, the use of the process through this material can then be extended to include a transparent review of the individualized analysis to more clearly understand an aggregation of prevailing and predominant sets of facts or consensus of ideas in the controlled sets of pages.

Grow: From this consensus of ideas, the use of the process through this new content can then be even further extended to include an objective analysis about these prevailing sets of ideas which can and should be applied to recommendations to governance, behavior, and policy surrounding the reviewed subject matter in the story or case. In essence this process is a truth engine designed to perform the work of deriving informational value through the sharing of relevant ideas and substantiated material in this new manner and technique where traditional book publication and social media or computer AI algorithms fall short and just cannot fully replicate or produce by themselves or in a less complete and accurate manner. The usefulness of this Leaders Lost process is that it brings the human back into the loop for identifying and deriving the most useful information towards a subject as the continuous engagement by the public users make it more possible and easier to pinpoint the truth in the matter derived from us, not from sets of algorithms' best guesses at interpreting us through data mining of big data. We in turn become the source of the truth through our own accountability created through the Leaders Lost process and we can grow together in common understanding as a result.

### Other Legal Attributes

The Leaders Lost Process is a tangible process using and leveraging tangible tools and machines or algorithms to create tangible and real analytic, interesting, and entertaining results for learning, academia, and collaboration in order to reconcile, arrive at, and understand the most perfect degree of truth and learning behind benign and sometimes very difficult stories, cases and topics. The Leaders Lost Process is very much more tangible than abstract, it does not represent itself or is represented by or within a common law of nature as it requires work put into it in order for it go and be successful in its endeavor, and the process does not occur as a natural phenomenon that just happens or occurs because participants or audience members must choose and actively engage in and enlist the process in order to use it.

The Leaders Lost Process was not known to the public before filing for this patent. The Leaders Lost Process was not in a printed publication before filing for patent protection. The Leaders Lost Process was not described in a published patent application for issued patent before filing for this patent.

The Leaders Lost Process is a new and unique tool applied for use alongside but independent of (like a windshield wiper riding along on a separate vehicle but whose use is independent of the vehicle and can be useful riding along other types of vehicles that can benefit from or simply transport the application for its use) existing social and collaborative structures, processes, and machines created in order to do and enable the more complete work of assisting the public and body politics' ability to search for, study, identify, understand, and learn from a baseline of open and transparent collaboratively established sets of factually based information that is derived from, improved, and deliberated using Leaders Lost.

The Leaders Lost process begins with a baseline set of material derived in existing content most easily construed or recognizable as a book but could take the form of other types of media. Once started, the Leaders Lost process continuously performs its function of sharing and communicating relevant information that self generates a degree of relative informational value over time to drive closer and closer towards a consensus around a particular fact, idea, or piece of data. As the process builds, the usefulness of the material derived becomes most easily interpreted through the following three process elements or parts which each host individual degrees of uniqueness and when combined in totality through the complete technique provided by the Leaders Lost process, they become something more powerful and effective at creating relevant information outcomes. In its most basic application Leaders Lost process could also just be used for the entertainment of collaboration or content sharing dialogue and portrayal without the need for greater analysis or questioning.

### Live

### First Presentation of and Interaction With the Material

The usefulness of Leaders Lost starts by taking the content of a large complex theme, case, or story and breaks the content and the associated ideas up and presents the material by individual pages or smaller content structures on various social media applications and other traditional publishing methods to give the audience the chance to digest comprehend and provide feedback on small and targeted amounts of the individualized content. No book or case volume has been presented on social media in the manner described here using this process before.

### Shine

### Second Review and Digestion of the Material

Next Leaders Lost gives the audience the ability and access to have a complete open and transparent dialogue or bank of information about the individualized content which can further be used and applied in support of simple review and entertainment purposes to engage with and exchange in traditional social media form, or can be used towards complex academic and other similar analysis to better understand the true nature or truth behind the content. In the same way calculus is used to study the changes taking place across the lifespan of a function Leaders Lost makes it possible to glean a more complete understanding of the truth behind the content as it changes over time through the audiences' engagement of the material more and more towards the limit represented by the most common reviewed and agreed upon understanding or consensus. This part of the Leaders Lost process provides the mathematical or scientific peer review process style approach to recognize and understand where and how the changes in the material or story exist and what these changes tell us within the context of the story, organized, documented, and categorized by each page.

### Grow

### Third Analysis of and Learning From the Material

Leaders Lost cannot change human behavior from bad to good, self-interested human behavior will forever persist as a prevailing characteristic of the human condition, but Leaders Lost provides a modicum for the advancement of truth and accountability through continuous gathering and organization of targeted information around the necessary ideas and themes that are determined to be of enough value to be reviewed and analyzed. This last part creates the conditions favorable for reaching objective conclusions about the facts and truth surrounding the key themes of the story that we collectively can then see be applied towards recommended changes for more effective constructive laws and policies that Can have the power to influence human behavior and make a positive difference towards the advancement of the human condition.

This invention, or the parts constructed thereof are not obvious to a person having ordinary skill due to the fact that the Leaders Lost process has not been used by or presented by or described by anybody or by an organization before otherwise people would've already done it and you would see Leaders Lost being used on a grand scale across society and in academia/government.

Leaders lost services and potential franchises provide and deliver leaders lost services and products for public consumption and analysis. Each franchise opportunity could extend and apply leaders lost to a new informative or entertaining volume of content that the information owner feels needs to be made available in the public space using the Leaders Lost process.

1. The Leaders Lost Process allows your story to Live by digitally publishing the content or material in a manner that interactively breaks this information down (however complex) into (more digestible) individual pieces or pages for global public (or private) audience consumption in real time using consistent identification and separation controls and techniques through its own application or applied over the top of existing application types such as social media or other types such as youtube.

2. The Leaders Lost Process allows your story to Shine by providing the audience an open and transparent digital forum for engaging the individualized parts of the story in a manner that creates new and interesting dialogue surrounding the themes and ideas or other information being presented in the story in a controlled format through consistent identification and separation controls and techniques.

3. The Leaders Lost Process allows your story to Grow by creating an open opportunity for learning for all through the digital data bank of collective insights and new ideas created through the digital forum of controlled format dialogue presented using the digitally published content from the consistent identification and separation controls and techniques.
